(19) United States
(12) Patent Application Publication
(10) Pub. No.: US 2003/0135734 A1
(43) Pub. Date: Jul. 17, 2003

(54) Secure mutual authentication system

(76) Inventors: Robert H. Fagan, Hockessin, DE (US); Robert A. Mckosky, Newark, DE (US); G. Eric Babcock, Newark, DE (US); Meenu Gupta, Wilmington, DE (US)

Correspondence Address: VENABLE, BAETJER, HOWARD AND CIVILETTI, LLP, P.O. BOX 34385, WASHINGTON, DC, 20043-9998, US

(21) Appl. No.: 10/043,879

(22) Filed: Jan. 14, 2002

(51) Int. Cl. H04L 9/00

(52) U.S. Cl. 713/169

(57) ABSTRACT

For secure mutual authentication, a customer is authenticated at a first web site. A selection is received from the customer at the first web site requiring transfer to a second web site. An authentication message for the customer is generated at the first web site. The authentication message is devoid of intelligent information of the customer. The authentication message is transferred from the first web site to the second web site for authentication of the customer by the second web site.

### BACKGROUND OF THE INVENTION

1. Field of the Invention

The present invention relates generally to Internet web site user authentication, and more particularly to sharing authentication information securely among partnering web sites.

2. Related Art

Many Internet web sites maintain information about their customers, including addresses, phone numbers and even credit card account numbers. Increasingly, companies are moving toward partnerships among different sites to provide the user with more choices at one site than the user would have if that site were not partnered with another. For example, a bank customer may wish to access all of their associated accounts, such as credit cards, checking, savings and certificates of deposit. The bank, however, may not service all of the customer's accounts. The bank may have a partnership with another financial institution to manage some of their customers' accounts. Users wishing to access their stored information must usually log in with a user name and password, or some other authenticating information, to each institution's web site.

Currently, if a user is moved from one site requiring authentication to another, the user must log in to the second site in order to have access to the personal account information at the second site. This can be frustrating to the user, who must remember multiple log-in identifications and passwords for multiple sites. Additionally, pausing for another log-in procedure interrupts the user's flow of activity. When customer information must be shared, sharing customer information securely is problematical because security can still be breached, and maintaining customer information across different sites increases the complexity of such maintenance.

What is needed is a system for authenticating customer identity across partnered web sites securely and seamlessly for the customer.

### SUMMARY OF THE INVENTION

In an exemplary embodiment of the present invention, a customer accesses multiple web sites, where each such web site typically requires a customer to log in before allowing access to some or all of the web site. The web sites can be independent from each other (e.g., operated or owned by separate enterprises). The mutual authentication method is a protocol that allows customers to move back and forth among various web sites without having to log in more than once. Customers only log in and authenticate to the first web site they access. The web site passes the authentication information to the next web site the customer desires to access. The next web site reads this authentication information and makes a decision on whether to grant access or not. Except for the very first time this authentication transaction occurs at the next web site, the customer is not prompted to log in by the next web site.

In one embodiment of the present invention, the first web site creates a special pseudonym, unique to each customer, that identifies the customer to the partner web sites, but that does not contain customer information useable to an outside source, such as a hacker. The pseudonym can be transferred from web site to web site with accompanying data that together constitute an authentication message.

The method of the invention includes a method for secure mutual authentication. The method comprises the steps of: authenticating a customer at a first web site; receiving a selection from the customer at the first web site requiring transfer to a second web site; generating an authentication message for the customer at the first web site, the authentication message devoid of intelligent information of the customer; and transferring the authentication message from the first web site to the second web site for authentication of the customer by the second web site. The method further comprises the step of authenticating the customer at the second web site using the authentication message generated by the first web site.

The method of the invention includes another method for secure mutual authentication. The method comprises the steps of: receiving at a second web site an authentication message for a customer from a first web site, the customer previously authenticated by the first web site, the authentication message generated by the first web site, the authentication message devoid of intelligent information of the customer; and authenticating the customer at the second web site using the authentication message generated by the first web site. The method further comprises the step of prompting the customer to log in to the second web site when the customer has not previously visited the second web site. The method additionally comprises the step of returning the customer from the second web site to the first web site using a uniform resource locator without further authentication by the first web site. The method still further-comprises the step of generating the authentication message for the customer at the first web site.

The system of the invention includes a computer system including a computer-readable medium having software to operate a computer in accordance with the invention.

The apparatus of the invention includes a computer including a computer-readable medium having software to operate the computer in accordance with the invention.

The article of manufacture of the invention includes a computer-readable medium having software to operate a computer in accordance with the invention.

Further features and advantages of the invention, as well as the structure and operation of various embodiments of the invention, are described in detail below with reference to the accompanying drawings.

Definitions

A “computer” refers to any apparatus that is capable of accepting a structured input, processing the structured input according to prescribed rules, and producing results of the processing as output. Examples of a computer include: a computer; a general purpose computer; a supercomputer; a mainframe; a super mini-computer; a mini-computer; a workstation; a micro-computer; a server; an interactive television; a hybrid combination of a computer and an interactive television; and application-specific hardware to emulate a computer and/or software. A computer can have a single processor or multiple processors, which can operate in parallel and/or not in parallel. A computer also refers to two or more computers connected together via a network for transmitting or receiving information between the computers. An example of such a computer includes a distributed computer system for processing information via computers linked by a network.

A “computer-readable medium” refers to any storage device used for storing data accessible by a computer. Examples of a computer-readable medium include: a magnetic hard disk; a floppy disk; an optical disk, such as a CD-ROM and a DVD; a magnetic tape; a memory chip; and a carrier wave used to carry computer-readable electronic data, such as those used in transmitting and receiving e-mail or in accessing a network.

“Software” refers to prescribed rules to operate a computer. Examples of software include: software; code segments; instructions; computer programs; and programmed logic.

A “computer system” refers to a system having a computer, where the computer comprises a computer-readable medium embodying software to operate the computer.

A “network” refers to a number of computers and associated devices that are connected by communication facilities. A network involves permanent connections such as cables or temporary connections such as those made through telephone or other communication links. Examples of a network include: an internet, such as the Internet; an intranet; a local area network (LAN); a wide area network (WAN); and a combination of networks, such as an internet and an intranet.

### BRIEF DESCRIPTION OF THE DRAWINGS

The foregoing and other features and advantages of the invention will be apparent from the following, more particular description of a preferred embodiment of the invention, as illustrated in the accompanying drawings. The left most digits in the corresponding reference number indicate the drawing in which an element first appears.

FIG. 1 shows a flowchart of an exemplary embodiment of the present invention;

FIG. 2 illustrates an exemplary embodiment of an authentication message according to the present invention;

FIG. 3 illustrates an exemplary embodiment of authenticated data according to the present invention;

FIG. 4 illustrates a flowchart of authentication in an exemplary embodiment of the present invention;

FIG. 5 illustrates a plan view for a computer system for the invention; and

FIG. 6 generally illustrates the process of the invention.

### DETAILED DESCRIPTION OF AN EXEMPLARY EMBODIMENT OF THE PRESENT INVENTION

A preferred exemplary embodiment of the invention is discussed in detail below. While specific exemplary embodiments are discussed, it should be understood that this is done for illustration purposes only. A person skilled in the relevant art will recognize that other components and configurations can be used without parting from the spirit and scope of the invention. The embodiments and examples discussed herein are non-limiting examples.

Mutual authentication is the process by which a customer is allowed access to multiple partnering web sites through the sharing of customer authentication information among these web sites to enable a seamless transaction for the customer. The web sites can be independent of each other (e.g., operated or owned by separate enterprises). In an exemplary embodiment, the partner sites communicate via a pre-defined protocol that minimizes the customer data that needs to be stored and synchronized between the sites. This protocol is defined as part of the security model as described below. The communication protocol can be customized between the partner pairs.

The system of the invention provides for a connection-less customer authentication between partnering web sites. A customer can log in at either site and continue her or his transactions without having to log in when re-directed to a partnering web site.

The inventive system provides for uniquely identifying the customer. Authentication is trust-based and “mutual.” A customer logs in to the first web site, and the customer is authenticated. The second web site trusts the authentication performed by the first web site. If the second web site forwards the customer back to the first web site or another partnering web site, the customer is not re-authenticated as long as the receiving web site trusts the second web site. This process can be started at any of the partnering web sites.

The inventive process is generally illustrated in FIG. 6. For example, suppose that site A and site B are two web sites representing two enterprises. For example, site A could be a bank, and site B could be a credit card company that services the bank's credit card needs. A customer can transact business with both enterprises, which share data for the customer. Both enterprises have a partnership agreement to conduct business that involves data for the customer. Both web sites must authenticate a customer before allowing the customer to conduct business at the web site. When the customer conducts business on site A, and if site A needs to transfer this customer to site B, only site A authenticates the customer. Site A then passes the authentication information to site B, such that the transaction appears seamless to the customer. However, when the customer desires to conduct business on site B that is not part of the partnership agreement, the customer must still log on to both web sites separately.

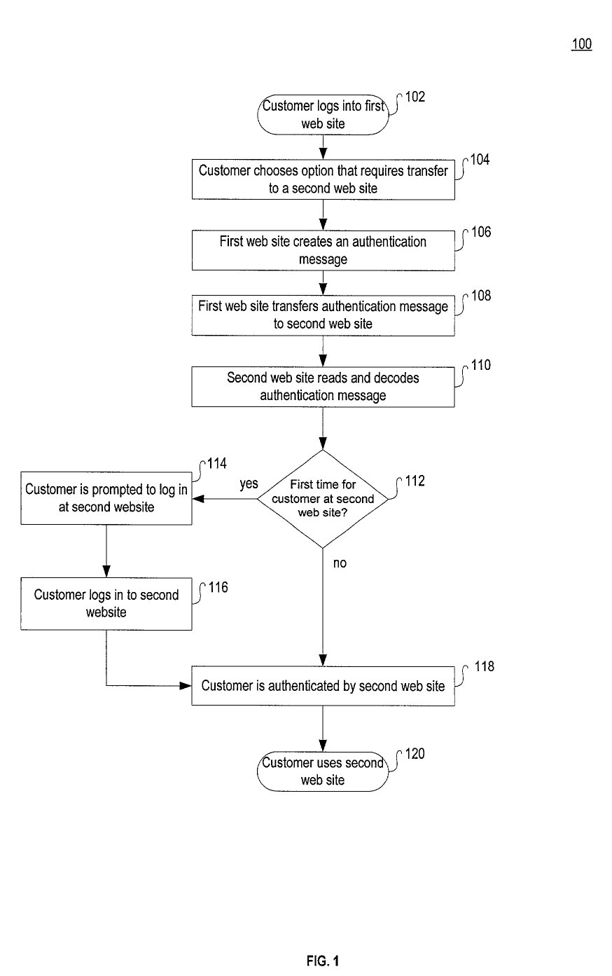

FIG. 1 shows a flowchart 100 of an exemplary embodiment of the present invention. At the beginning of the process, the customer logs in to a first web site (site A) in step 102. In step 104, while using the first web site, the customer chooses an option that requires being transferred to a partnering second web site (site B). Site A creates an authentication message in step 106. In step 108, site A next transfers the authentication message to site B. In step 110, site B reads and decodes the authentication message. If the customer has not yet used site B in step 112, or if the customer has not yet used site B's mutual authentication facility, the customer is prompted to enroll and/or log in to site B in step 114. In step 116, the customer logs in to site B. Next, or if the customer has already enrolled in or used site B, the customer is authenticated by site B in step 118. The customer is authenticated using the authentication message prepared by site A. Finally, in step 120, the customer is able to access and use site B. If the customer decides to go back to site A (or another partnering web site), no further authentication from site B to site A (or the other partnering web site) is needed. The customer can be returned to the site A via an optional return uniform resource locator (URL) included with the authentication message (see FIG. 6).

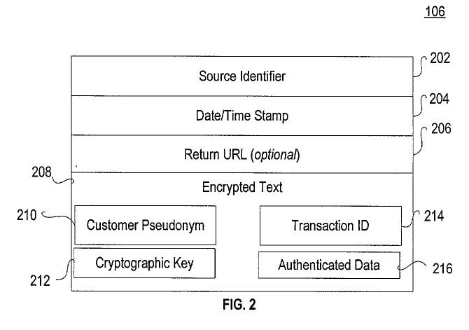

FIG. 2 illustrates an exemplary embodiment of an authentication message from step 106 according to the present invention. The authentication message can include a source identifier 202, a date/time stamp 204, an optional URL 206, and encrypted text 208. The encrypted text 208 can contain data such as a customer pseudonym 210, a cryptographic key 212, a transaction identification (ID) 214, and authenticated data 216.

The source identifier 202 can be an organizational unit identifier of a group within a sending partner web site, which is used as an index to a database that contains the appropriate set of cryptographic keys for decrypting the message and other information about the partner.

The date/time stamp 204 is the date and/or time of the generation of the authentication message.

The optional return URL 206 is a URL for the first web site and can be used to send the customer back to the first web site.

The authentication message includes an unencrypted portion and an encrypted portion. The unencrypted portion includes the source identifier 202, the date/time 204 and the return URL 206. The encrypted portion 208 includes the customer pseudonym 210, the cryptographic key 212, the transaction ID 214 and authenticated data 216. With the unencrypted portion, verification of the message source can be accomplished. Decryption attempts are made by the receiving web site once the origin of the message is verified. This step occurs in step 108, when the authentication message is received by site B. Due to the customer pseudonym 210, encryption is not as essential as in prior art systems. However, part of the message can be digitally signed and encrypted. The cryptographic key 212 can be a public or private key, depending upon industry standards and the applicable implementation agreement between the partnering sites.

The customer pseudonym 210 is a non-intelligent string of characters that uniquely identifies the customer to a specific partner web site. The pseudonym itself is devoid of any intelligent information to link it back to the customer and only has meaning to the partnering sites, which makes it safe to be transmitted over the Internet. In this context, “intelligent information” refers to information that has meaning independent of the web site associated with it. For example, the pseudonym does not include intelligent information, such as a user name of the customer, a password of the customer, or an account number of the customer, such as a credit card number or a bank account number. Because only the trusted entities that share the customer data have intelligence about the pseudonym, the customer pseudonym is safe for transmission over the Internet. An important requirement for the pseudonym is that it is not, nor can it be, linked, except by site A and site B, to any customer account number or other unique features of a customer. The pseudonym must be unique for a specific customer from a specific site. In operation, the same pseudonym could be generated by different partner sites and still be valid.

In an exemplary embodiment, the customer pseudonym 210 can be a string of alpha-numeric characters, preferably 6-8 in number, that is linked to a valid customer by both site A and site B. Site A can generate a unique pseudonym for each customer based on a mechanism agreed upon by the partner sites. Pseudonyms can be generated, for example, by a random choice or hash method where the value generated is checked for uniqueness. In one embodiment, the customer pseudonym is created through a one-way process rather than via encryption. Once the pseudonym is received as part of the authentication message, it can be used to retrieve the customer information on site B. Once created, a customer's pseudonym is permanent and does not have to be re-generated at each log-in.

The transaction ID 214 identifies the transaction of transferring the customer to the second site and can include the source identifier 202, the date/time stamp 204, and the customer pseudonym 210. Instead of using the transaction ID 214, the source identifier 202, the date/time stamp 204, and the customer pseudonym 210 together can be used as a unique transactional identifier.

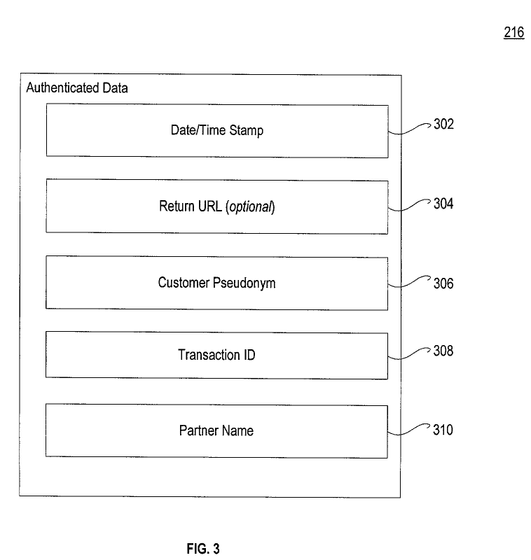

The authenticated data 216 is additional information, which further validates the authenticity of the message. FIG. 3 illustrates an exemplary embodiment of authenticated data 216 according to the present invention. Authenticated data 216 can include a date/time stamp 302, an optional return URL 304, a customer pseudonym 306, a transaction ID 308, and a partner name 310. The date/time stamp 302 is the same as the date/time stamp 204, the return URL is the same as the optional return URL 206, the customer pseudonym 306 is the same as the customer pseudonym 210, and the transaction ID 308 is the same as the transaction ID 214. The partner name 310 is the name of the participating institution that generated the authenticated data 216. Other types of information can be included in the authenticated data 216, such as additional partner or account-related information.

In one embodiment, the mutual authentication of a customer from web site A to web site B can be performed using a process called POST, which is a well-known standard HTTP command. The POST is the format used for the authentication message and can be transmitted within a 128-bit protected secured socket layer (SSL) session. The POST can contain the source identifier 202, the date/time stamp 204, the optional return URL 206, the customer pseudonym 210, and encrypted data 208. In the POST, the source identifier 202 and the date/time stamp 204 are not encrypted because site B can use this information to determine which cryptographic keys are necessary to evaluate the message.

With the POST, the encrypted data can use, for example, up to three sets of keys, for instance, a public key (e.g., for key management), a symmetric key (e.g., for message confidentiality) and an asymmetric key (e.g., for message authentication of digital signatures). In an exemplary embodiment, the public key can be used to exchange symmetric and asymmetric keys among partner sites. The symmetric and asymmetric keys, for example, can be distributed with a pre-specified life span. For instance, one key could have a one-year life span, and other keys could have a one-month life span. In the exemplary embodiment, the symmetric key can encrypt any information that will not be in the clear, and the asymmetric key can be used to sign messages.

Site A digitally signs all information presented in the POST. Encrypted information is signed with the clear-text source identifier 202 and the date/time stamp 204. The digital signature validates at a minimum the date/time stamp 204, the return URL 206 (if included in the POST), and the customer pseudonym 210. Digital signatures are well known in the art.

As an example, the POST can be:

OU=<SourceIdentifier>

DT=<datetime>

RT=<returnURL>(an optional field)

ET=<EncryptedText>

where

<EncryptedText>:=[symmetric-key](<trans-id>, <pseudonym>, <AuthenticatedData>) and

<AuthenticatedData>:=[asymmetric-key](<trans-id>, <partner_name>, <datetime>, <returnURL>, <pseudonym>)

In the POST, the SourceIdentifier is the source identifier 202. The datetime is the date/time stamp 204. The returnURL is the return URL 206 and is optional. The EncryptedText is information that is encrypted with a symmetric key. Of the encrypted information, the trans-id is the transaction ID 214, and the pseudonym is the customer pseudonym 210. The AuthenticatedData is information that is encrypted with an asymmetric key. Of the AuthenticatedData information, the trans-id is the transaction ID 308, the partner_name is the partner name 310, the datetime is the date/time stamp 302, the returnURL is the return URL 304 and is optional, and the pseudonym is the customer pseudonym 306.

The customer is allowed to access site B from site A upon verification and acceptance that, at least: site A's signature is valid; the pair of the customer pseudonym and the date/time stamp has not been previously used; and the date/time stamp is within site B's acceptable limit. The acceptance time period can be varied in site B's system. These verification steps ensure that that the message came from a trusted partner. The verification steps also prevent an intruder from capturing the transaction and replaying it to gain access to the secure site.

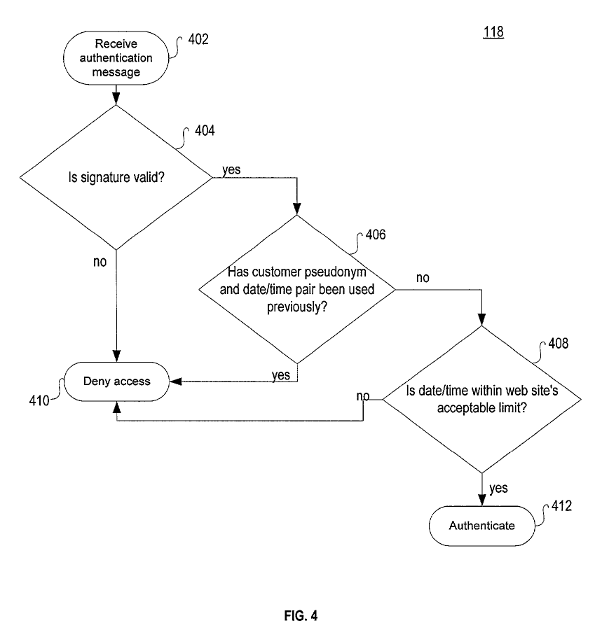

FIG. 4 illustrates a flowchart of the authentication step 118 in FIG. 1 for an exemplary embodiment of the present invention. When site B receives the authentication message from site A in step 402, site B checks that the signature from Site A is valid in step 404. If the signature is not valid, access is denied to site B in step 410. If the signature is valid, site B checks, in step 406, if the customer pseudonym and the date/time stamp have been used before. If the date/time stamp has been used before, the authentication message has probably been duplicated, indicating that the security of the transaction was breached. Access is therefore denied in step 410. If the pseudonym and the date/time stamp have not been used before, site B checks in step 408 that the date/time stamp is within site B's acceptable limit, for example, 10 minutes. A date/time stamp that is not within the acceptable limit could indicate that the customer has gone to other non-partnered web sites, or that an intruder has captured the transaction and is attempting to replay the transaction. If the date/time stamp is within the acceptable limit, the customer is authenticated at web site B in step 412. Otherwise, access is denied in step 410, and the customer must retry or authenticate in another manner.

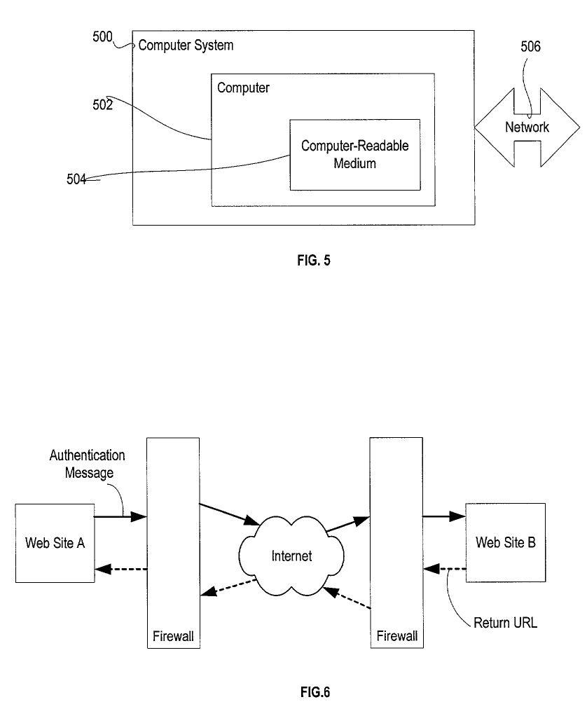

FIG. 5 illustrates a plan view for a computer system for implementing a web site of the invention. The computer system 500 includes a computer 502 for implementing the invention. The computer 502 includes a computer-readable medium 504 embodying software for implementing the invention and/or software to operate the computer 502 in accordance with the invention. The computer system 500 includes a connection to a network 506.

Although the invention has been described for use with the Internet, other types of networks can be used with the invention, as will be appreciated by those skilled in the art.

Although the invention has been generally described for use with two partnering sites, the invention can be used with multiple partnering sites, as will be appreciated by those skilled in the art.

The embodiments and examples discussed herein are non-limiting examples.

While various embodiments of the present invention have been described above, it should be understood that they have been presented by way of example only, and not limitation. Thus, the breadth and scope of the present invention should not be limited by any of the above-described exemplary embodiments, but should instead be defined only in accordance with the following claims and their equivalents.

What is claimed is:

1. A method for secure mutual authentication comprising the steps of:
authenticating a customer at a first web site;
receiving a selection from said customer at said first web site requiring transfer to a second web site;
generating an authentication message for said customer at said first web site, said authentication message devoid of intelligent information of said customer; and
transferring said authentication message from said first web site to said second web site for authentication of said customer by said second web site.

2. The method of claim 1, wherein the step of generating an authentication message comprises incorporating a customer pseudonym into said authentication message, said customer pseudonym uniquely identifying said customer and devoid of intelligent information of said customer.

3. The method of claim 2, wherein the step of generating an authentication message further comprises randomly generating said customer pseudonym.

4. The method of claim 2, wherein the step of generating an authentication message further comprises incorporating a date/time stamp, a partner name and an optional uniform resource locator (URL) with a return address for said first web site into said authentication message.

5. The method of claim 1, wherein the step of generating an authentication message comprises incorporating a source identifier, a date/time stamp, an optional return URL, a customer pseudonym, a cryptographic key, a transaction identification and authenticated data for the first web site into said authentication message.

6. The method of claim 5, wherein said authenticated data comprises said date/time stamp, said optional return URL, said customer pseudonym, said transaction identification, and a partner name.

7. The method of claim 1, further comprising the step of authenticating said customer at said second web site using said authentication message generated by said first web site.

8. A computer for performing the method of claim 1.

9. A computer-readable medium having software for performing the method of claim 1.

10. A method for secure mutual authentication comprising the steps of:
receiving at a second web site an authentication message for a customer from a first web site, said customer previously authenticated by said first web site, said authentication message generated by said first web site, said authentication message devoid of intelligent information of said customer; and
authenticating said customer at said second web site using said authentication message generated by said first web site.

11. The method of claim 10, wherein the step of authenticating said customer at said second web site occurs when said customer has previously visited said second web site, and further comprising the step of prompting said customer to log in to said second web site when said customer has not previously visited said second web site.

12. The method of claim 10, wherein said authentication message comprises a uniform resource locator (URL) with a return address for said first web site, and further comprising the step of returning said customer from said second web site to said first web site using said URL without further authentication by said first web site.

13. The method of claim 10, further comprising the step of generating said authentication message for said customer at said first web site.

14. A computer for performing the method of claim 10.

15. A computer-readable medium having software for performing the method of claim 10.

16. A computer system for secure mutual authentication comprising a first web site and a second web site;
said first web site to authenticate a customer, receive a selection from said customer requiring transfer to said second web site, generate an authentication message, and transfer said authentication message from said first web site to said second web site, said authentication message devoid of intelligent information of said customer; and
said second web site to receive said authentication message for said customer from said first web site and authenticate said customer using said authentication message generated by said first web site.
